(19) United States
(12) Patent Application Publication
(10) Pub. No.: US 2002/0004742 A1
(43) Pub. Date: Jan. 10, 2002

(54) Time variable incentive for purchasing goods and services

(76) Inventors: Neil A. Willcocks, Flanders, NJ (US); Thomas M. Collins, Nazareth, PA (US); Kevin L. Rabinovitch, Hackettstown, NJ (US); Mark J. Chimel, Long Valley, NJ (US); Henry V. Izzo, Bridgewater, NJ (US); Robert W. Tuttrup, Sparta, NJ (US); Kevin J. Stanton, Califon, NJ (US)

Correspondence Address: FITZPATRICK CELLA HARPER & SCINTO, 30 ROCKEFELLER PLAZA, NEW YORK, NY, 10112, US

(21) Appl. No.: 09/731,834

(22) Filed: Dec. 8, 2000

Related U.S. Application Data
(60) Provisional application No. 60/217,070, filed on Jul. 10, 2000.

(51) Int. Cl. G06F 17/60

(52) U.S. Cl. 705/14

(57) ABSTRACT

An apparatus and method for motivating a consumer to promptly indicate an interest in purchasing a product and/or service over a computer network includes the steps of presenting an offer for sale of a product and/or service to the consumer over the computer network, concurrently presenting an incentive for purchasing the product and/or service to the consumer promptly over the computer network. The incentive is initially set to a predetermined maximum value and decreases over a period of time. Additional steps include indicating an interest to purchase the product and/or service by the consumer at a point in time during the period of time, and providing the consumer the current value of the incentive corresponding to the point in time at which the consumer indicated the interest.

### BACKGROUND OF THE INVENTION

1. Field of the Invention

The present invention relates to apparatuses and methods for providing an incentive for purchasing goods and/or services. Most particularly, this invention relates to apparatuses and methods for providing a time variable incentive for purchasing goods and/or services. In a preferred embodiment of the present invention, time variable incentives are provided for purchasing goods and/or services online, such as at a World Wide Web site.

2. Related Background

Much of consumer sales is based upon the impulse purchasing phenomenon, i.e., the phenomenon of a consumer deciding on the spur of the moment either sua sponti or through some external force, that he or she desires an item, and making the purchase immediately. Impulse purchasing is best illustrated by the candy display at the checkout counter of a grocery store. Most people who purchase the candy there did not set out to buy candy when they visited the store, but were instead motivated to make the purchase by seeing the candy on display. This attractiveness at the display, coupled by the immediate availability of the candy, causes the consumer to make the purchase.

Products/services presented for sale on the Internet are usually presented to the consumer as a small image (icon) of the product on a particular Web site, with the purchase price for the product positioned immediately adjacent thereto. By selecting (clicking) on the image, the user is directed to a purchasing area of the Web site, in which the user enters purchasing information relating to the consumers name, address, payment and shipping information to complete the transaction.

Most Web site shopping models are premised on the purchased items being shipped to the consumer via a paid carrier, such as United Parcel Service, Federal Express and the like. In such systems, the purchased items will typically take at least a day, and usually longer, to make their way to the consumer.

This lag presents an added challenge in motivating impulse purchases on the Web; simply put, it is more difficult to motivate consumers to make impulse purchases when they will not be able to immediately enjoy what they have paid for.

One way to promote impulse purchasing on the Internet is through the use of incentives in the form of a lower price, discount or award for purchasing a product and/or service. One form of discount that has been widely used as a purchasing incentive is the use of discount coupons in electronic or paper form. Electronic coupons are conventionally sent by electronic mail to a consumer, while paper coupons are conventionally provided to consumers through a periodical or via a traditional paper. In the case of an electronic coupon, and sometimes paper coupons as well, an alphanumeric code is included with the coupon for redemption purposes. In order to redeem the coupon for a product or service and gain benefit of the discount, the code is entered by the consumer in a discount code entry field located on a check-out area of a participating Web site. The value of the coupon is then applied to the consumer's total to discount the amount that he or she is charged.

Conventional coupons, either electronic or paper, however, do little, if anything, to motivate impulse purchases for they generally have a fixed lifespan (i.e., a fixed date upon which they will expire) and a fixed value over the course of that lifespan. Thus, a consumer receiving such a coupon will note its value and its expiration date, and will have a known window of time during which he or she may use the coupon to make the relevant purchase. Such a conventional coupon, therefore, will not motivate an impulse purchase.

There exists a need, therefore, for an apparatus and method which takes an entirely fresh approach and effectively motivates consumers at an e-commerce Web site to make impulse purchases.

### SUMMARY OF THE INVENTION

The present invention addresses the above concerns and presents new and novel apparatuses and methods for providing an incentive for prompt purchase of products and/or services on the Internet. Moreover, the present invention lends itself to any incentive which decreases from a maximum value to a minimum value on any media, especially the Internet, outdoor and indoor visual advertising displays, television, radio, telephone and traditional media including newspapers and other periodicals.

In one aspect of the present invention, a method for motivating a consumer to promptly indicate an interest in purchasing a product and/or service includes the steps of presenting an offer for sale of a product and/or service to the consumer, concurrently presenting to the consumer an incentive for purchasing the product and/or service promptly. The incentive decreases over a period of time.

The incentive methods according to the present invention may be initially set to a predetermined maximum value to decrease to a minimum value, which could include no incentive value.

The above method for motivating a consumer to promptly purchase a product and/or service also may further include the steps of indicating an interest to purchase the product and/or service by the consumer at a point in time during the period of time that the incentive is given and providing the consumer the current value of the incentive corresponding to the point in time at which the consumer indicated interest.

In another aspect of the present invention, an apparatus for motivating a consumer to promptly indicate an interest in purchasing a product and/or service over a computer network includes means for presenting an offer for sale of a product and/or service from a server computer over the computer network to a consumer's computer, means for concurrently presenting an incentive for purchasing the product and/or service promptly, wherein the incentive is initially set to a predetermined maximum value and decreases over a period of time, means for indicating an interest to purchase the product and/or service by the consumer at a point in time during the period of time, and means for providing the consumer the current value of the incentive corresponding to the point in time at which the consumer indicated interest.

In yet a further aspect of the present invention, a system for motivating a consumer to promptly indicate an interest in purchasing a product and/or service over a computer network with the consumer operating a customer terminal operable to act as a client on a network. The system includes a host controller having a computer operable to act as a server on the computer network and to communicate with the customer terminal over the computer network. The system further includes data storage accessible to the host controller for storing information relating to the products and/or services offered for purchase to the consumer. The host controller is operable for presenting an offer for sale of a product and/or service from the server over the computer network to the customer terminal and for concurrently presenting an incentive for purchasing the product and/or service promptly from the server over the computer network to the customer terminal. The incentive is initially set to a predetermined maximum value and decreases over a period of time. The host controller is also operable for receiving an indication of interest to purchase the product and/or service by the consumer from the customer terminal at a point in time during the period of time and for providing the consumer the current value of the incentive corresponding to the point in time at which the consumer indicated interest.

In yet another aspect of the present invention, code executable on a computer includes code for presenting an offer for sale of a product and/or service to a consumer over a computer network, code for concurrently presenting an incentive over the computer network for purchasing the product and/or service to the consumer promptly, where the incentive decreases over a period of time, code for receiving an indication to purchase the product and/or service by the consumer at a point in time during the period of time, and code for providing the consumer the current value of the incentive corresponding to the point in time at which the consumer indicated the interest to purchase the product and/or service. The code according to this aspect of the present invention may be executable on a network server computer.

The embodiments of the present invention may also be operated via computer readable media bearing instructions which are operative to cause a computer to operate as recited in all the previous aspects of the present invention.

The methods and apparatuses of the present invention are especially applicable to e-commerce over the Internet, via a Web page, as a separate window, and as a web banner.

With these and other objects, advantages and features of the invention that may become hereinafter apparent, the nature of the invention may be more clearly understood by reference to the following detailed description of the invention, the appended claims and to the several drawings attached.

### BRIEF DESCRIPTION OF THE DRAWINGS

FIG. 1A is a block diagram of an Internet based implementation of the time variable incentive method and apparatus of the present invention.

FIG. 1B is a is a block diagram of a server/host computer of the Internet based implementation illustrated in FIG. 1A.

FIG. 2 is a flow diagram illustrating the process of the time variable incentive according to the present invention.

### DETAILED DESCRIPTION OF THE PREFERRED EMBODIMENT

In a preferred embodiment of the present invention, the system utilizes a wide area network (WAN) such as the Internet. The system preferably includes an Internet (TCP/IP compliant) server that interacts with consumer client computers using the client computer's graphical user interface (GUI), or any other interface in which a user can interact with a computer (e.g., voice commands, visual commands, and the like). The interface with the consumer preferably allows the consumers to interactively participate in electronic commerce, according to the present invention, and more preferably, the ability to promote impulse purchases of products and/or services at particular Web sites. The above functionality is preferably achieved using a combination of server side applications, such as common gateway interface programs (CGI), for allowing the server to accept search terms and interface with databases, and client side applets, such as Java applets, or the like, which execute in client browser software.

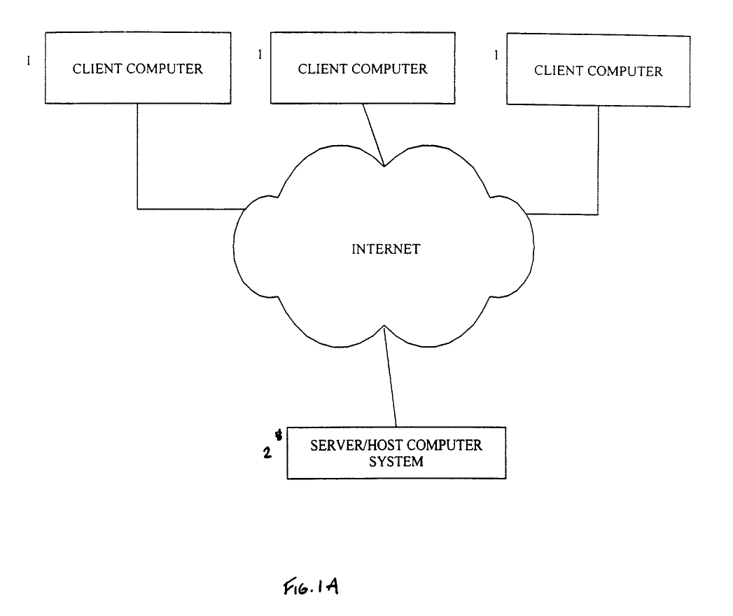

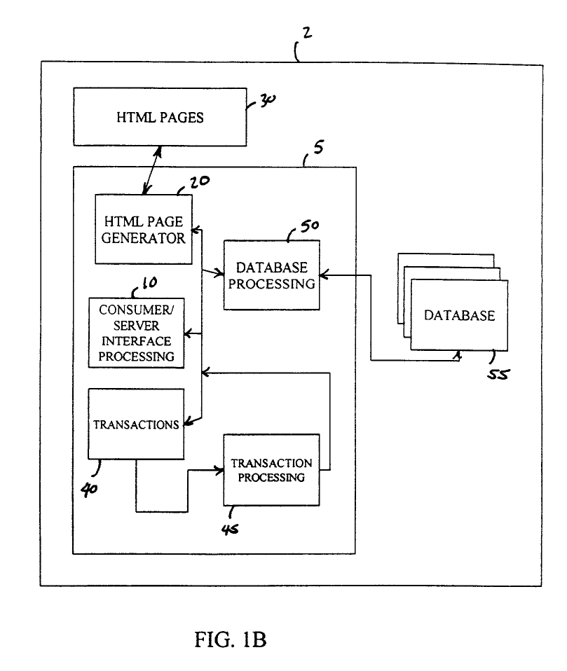

A preferred implementation of the time variable incentive for purchasing goods and/or services over a computer network according to the present invention is illustrated in block diagram form in FIG. 1A. In that figure, consumers operating client computers 1 are connected to a wide area network (WAN) such as the Internet. Such connection can be direct or via an Internet service provider (not shown). The client computers 1 each preferably include communications hardware and an operating system with graphical user interface (GUI) functionality to allow for interface with the Internet. Each client computer preferably has a graphical World Wide Web (Web) browser software, such as Netscape Navigator or Microsoft Internet Explorer, loaded thereon operable to read and send Hypertext Markup Language (HTML) forms from and to an Hypertext Transfer Protocol (HTTP) server on the Web. The client computer 1 preferably is operable to act as a virtual machine to run Java applets, or the like, downloaded by the browser from the server.

Server/host computer system 2 receives information from consumer client computers 1 over the Internet. The server/host computer system 2 preferably includes hardware, HTTP compliant software, an operating system and common gateway interface (CGI) software for interfacing with input queries and sources of data.

In operation, in the Internet implementation, a consumer typically would type in a Uniform Resource Locator (URL) of the server/host computer system 2 and receive from the server/host computer system 2 an interactive form, such as an HTML document, as well as any Java applets, or the like, necessary to allow the consumer to be presented with the products/services for the consumer to purchase according to the present invention. Such Java applet or the like may also be used so that the consumer may register at the particular site. In case of registration, the applets and CGI programs conduct verifications and ensure, for example, the consumer has not previously registered or is otherwise ineligible to participate for particular reasons.

A preferred implementation of a host site is illustrated in block diagram form in FIG. 1B. As shown in the figure, a vendor or server/host computer system 2 is controlled by software functions of server processing 5. Among the constituent software components within the server processing 5 is the consumer/server interface processing 10. Consumer/server interface processing 10 functions to interface with, among others in the preferred embodiment, vendor server 3 and client computers 1. Interface processing 10 executes functions in response to input from client computers 1 and initiates communication with the server computer. Dynamic page generator 20 responds to requests from the client computers 1 for HTML pages 30, which themselves are stored in the server. Transaction 40 stores information for the transaction and the transaction is completed by transaction processing module 45. Database processing 50 interfaces the server processing 5 with database 55.

In operation, in the Internet implementation, a consumer typically would type in a Uniform Resource Locator (URL) of the server/host computer system 2 and receive from the server/host computer system 2 an interactive form, such as an HTML document, as well as any Java applets, or the like, necessary to allow the consumer to view and indicate interest in purchasing products and/or services from the host Web site.

The server/host computer system 2 preferably communicates with a financial computer of the system to utilize input customer credit card information or the like for payment for a user's order when the user has indicated an interest in purchasing product/service according to the incentive method for the present invention.

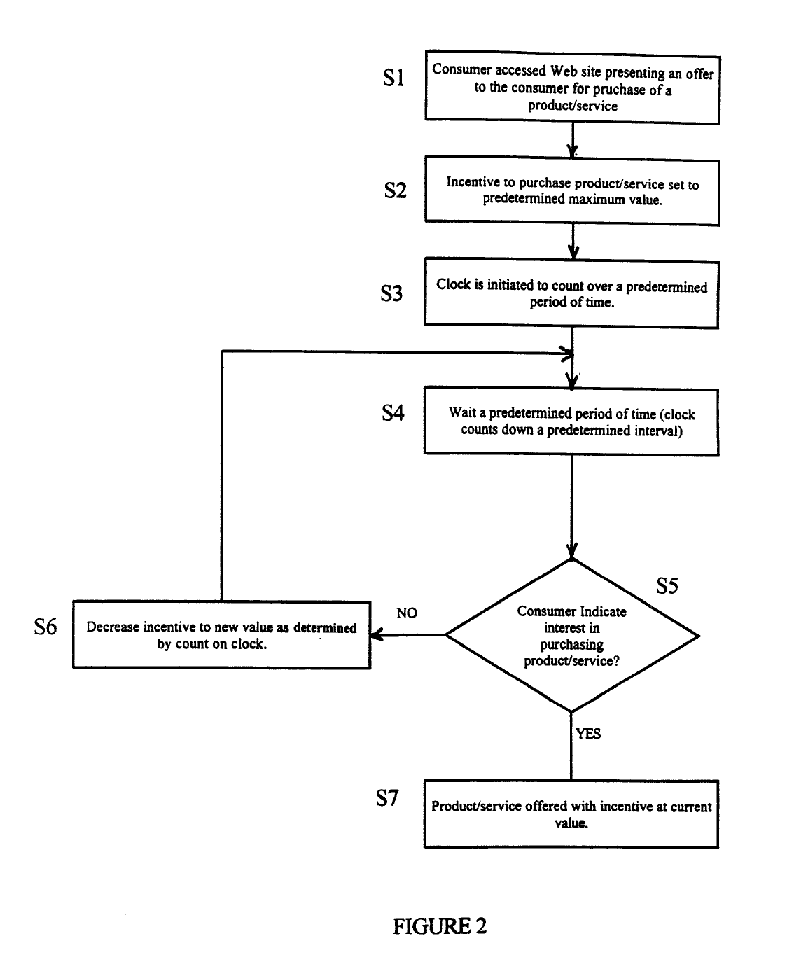

A preferred embodiment of the present invention operates in accordance with the flowchart provided in FIG. 2. In block S1, a consumer visits an e-commerce Web site of a vendor which lists offers for products and/or services for purchase over the Internet. The vendor Web site usually consists of a plurality of linked Web pages, each Web page listing information including products/services for sale, terms and conditions of sale, electronic bulletin boards for posting, for example, product reviews, and the like.

For the incentive method according to the present invention, a time variable incentive for purchasing products/services is provided. In block S2, as shown in FIG. 2, the time variable incentive is displayed in association with a particular product, where initially the incentive is set to a maximum predetermined value, and decreases over a period of time. A timing mechanism is initiated at a starting time which may be tracked on either the hosting Web site or the consumer's (client) computer (block S3) and counts down a predetermined interval (block S4). The consumer then decides whether he or she wishes to indicate an interest in purchasing the product and/or service (block S5). If the consumer does not indicate an interest, the incentive is decreased to a new value (block S6) corresponding to the amount of time that has passed since the last offer was initiated by the hosting Web site, and the process returns to block S4. For example, the initial maximum incentive for a particular product is set to, say, 30% off the regular purchase price. Thereafter, for every minute after the initial incentive is displayed, the incentive decreases by 5%. Ultimately, the minimum incentive may be set to a predetermined value (in the previous example, say, 5%), which may be a minimum incentive (e.g., 5%), or no incentive at all (0%).

When the consumer indicates that he wants to take advantage of the incentive offer, he selects (clicks) the acceptance link associated with the time variable offer (block S7). At the point in time when the consumer clicks on the acceptance link, the consumer is awarded with the value of the incentive at that time. Thus, in the previous example, if the consumer clicked on the associated acceptance link after 2.5 minutes, he would be awarded with a 20% discount off the purchase price of the product offered.

The incentive methods and systems according to the present invention are preferably operated via a software resident program (e.g., JAVA applet), which may be downloaded to the consumer's computer when the consumer initially accesses the hosting Web site. Thus, as soon as the hosting Web page is fully loaded onto the consumer's computer, along with the incentive method resident software, the incentive software is operated according to parameters established by the hosting Web site. These parameters include information relating to time period and max/min incentive for the particular offer. The incentive software performs the steps as outlined above for decreasing the incentive value over the established period of time.

The consumer may, however, attempt to fraudulently obtain a better max/min incentive and/or a slower timer or longer time period for receiving the incentive. This would probably be attempted by trying to manipulate the incentive method resident software to adjust the incentive/timing to a value more to the consumer's liking, or tampering with the timing instructions/mechanism.

In that regard, the incentive methods and systems according to the present invention may circumvent any such fraudulent attempt by creating a time register with the server of the host Web site, which registers the time, according to the server's clock, at which the incentive is initially displayed, and also registers an end time, according to the server's clock, at which the consumer indicates his acceptance of the incentive offer (i.e., the consumer clicks on the incentive icon). By comparing the incentive and timing determined by the resident software on the consumer's computer and comparing it with an appropriate incentive value and timing, the server computer can determine whether the awarded incentive is appropriate for the given time period. If the incentive is appropriate, then the transaction is allowed to proceed. If it is not, the server computer may issue a warning to the consumer, or may simply award the appropriate incentive for the given time period and proceed with the transaction.

The consumer may also fraudulently attempt to receive the maximum incentive by attempting to reset the incentive value to the maximum incentive by revisiting the hosting Web site or refreshing the hosting Web site Web page.

The present invention may be operated such that the maximum incentive for the product offered for sale is reset each time the consumer returns, preferred embodiments utilize visitor recognition and/or software and associated processes which recognize when a consumer has returned to Web site. Such processes may include Internet cookies to identify users returning to the site. Cookies are data which are placed in the user's computer memory when the user visits particular Web sites. The data contained on cookies may be any kind of information, including the last time the user has visited a particular Web site. Thus, if a user returns to the Web site hosting the incentive program, a different product/service will be offered to the returning user.

If the user has deleted the cookie relating to the hosting Web site, the Web site will not recognize that the user is returning to the Web site from a previous visit. Accordingly, the present invention may also be implemented by requiring the user to register before being exposed to special incentive offers, and login thereafter each time the user visits the site. Alternatively, the host Web site may also provide multiple random offers each time their Web page is refreshed or visited. However, this requires a large inventory of incentive items to thwart attempts by users from refreshing the vendor's Web page repeatedly until the particular item they are interested in is reoffered. Thus, it is preferred that the present invention be used in conjunction with consumer registration and return login.

The incentives used in the present invention may be a discount, like the previous example, or may be directed to the purchase price or quantity of the product/service, wherein the purchase price increases as a function of time. The incentive may also take the form of a product and/or service having a variable value. Thus, the maximum value would include a product/service having a high value which would decrease to a product/service having a lower value. For example, the maximum incentive may be a compact disc (CD) player having several features (bass boost, anti-skip and rechargeable battery), decreasing to a CD player having two features (bass boost, anti-skip), decreasing to a minimum incentive of a CD player having one feature (bass boost), or no features at all.

The incentive may also be tailored to correspond to a profile of the consumer. A consumer's profile may be information relating to the consumer's background, location, personal preferences, and historical behavior. Information related to personal preferences may be obtained simply by keeping track of the products/services the consumer purchases, or information entered by the consumer upon finalizing a purchase, or volunteered upon registration with the hosting Web site.

The incentive may further correspond to the awarding of premiums or points, frequent flyer miles, and the like. The premiums/points could be accumulated on the hosting Web site into a consumer's account, or an account of a participating corporation (airline) and cashed in for a particular product/service.

The time period in which the incentive decreases from maximum to minimum may also occur at a random rate. Thus, for example, the incentive method and system according to the present invention may gradually decrease from the maximum value to the minimum value, but vary therebetween.

The present invention may also reward consumers who frequently use the incentive system to purchase products/services. Thus, based on the number of times the consumer returns to the hosting Web site and purchases items with or without use of the novel incentive method, the particular consumer is rewarded. The reward may be in the form of a prize, such as a product or service, or may be in the form of changing the parameters of the incentive methods. Thus, the frequent consumer may be given a higher maximum incentive, a lower minimum incentive, or a slower timing or longer period of time.

The award may also take the form of providing the incentive methods for offered products more often than to regular visitors to the Web site.

The incentive methods and systems according to the present invention may also be used to purchase products for pickup at a local vendor. Specifically, when the user clicks on the offer link indicating an interest to purchase the particular product at a particular incentive, the consumer selects may select a local delivery option for specifying a local delivery vendor. A discount coupon with information relating to the purchase can then be printed by the users computer for presentation to the local vendor to pick up the item. Payment may be made preferably via the Web site, or at the local vendor.

Alternatively, a coupon need not be printed, but a code generated and given to the consumer. The consumer would then present the code to the local vendor to obtain the product.

To eliminate possible fraud for this embodiment of the present invention, the local vendor may receive a complimentary notification. For example, email from the hosting Web site with details of the purchase, such as name or other way to identify the consumer when he comes to pickup the product.

However, some local vendors may not have the resources available to receive email, or to phone/dial in to a central receiving office to verify the code/coupon. Accordingly, a unique set of alphanumeric codes for each particular local vendor, which is delivered via a regular delivery service to the local vendor, may be employed. Many coding methods familiar to one of skill in the art are available to produce a unique set of codes to prevent other fraudulent attempts at a consumer trying to produce a code for receiving a product/service at a particular incentive value with a particular local vendor. Thus, when a consumer specifies a local vendor for pickup, one of the unique codes particular to the local vendor is generated for the consumer. The local vendor would simply need to view the list of codes to authenticate it and thereafter, depending upon the particular coding system, cross the code from the list of codes.

For media other than the Internet, i.e., television, radio and telephone, an item may be displayed/discussed on a shopping program/advertisement, with the incentive decreasing until the viewer/consumer indicates an interest in purchasing the product. The indication for purchase may be given via the Internet or by the telephone.

With hardcopy media, an embodiment of the present invention may be used by displaying an advertisement promoting a product/service with a maximum listed incentive. The advertisement would include information relating to the process of decreasing incentive value and applicable time period. For example, the maximum incentive may be 40% off the list price of the product if the consumer purchases the product the day the advertisement is first published. The advertisement would then include information regarding the time period and lower incentive value associated thereto (e.g., every day or other time period including months, weeks, hours, minutes) until a minimum incentive of 10% or 0%).

The present invention also may be used with companion promotions of a plurality of vendors—one vendor might offer the product/service for purchase, and the other would offer the incentive. Such a companion promotion might involve an electronics manufacturer and a media company. For example, an incentive directed to the consumer might be receiving ten free video rentals from a local/franchise video rental establishment for purchasing a VHS player from the another vendor. As time passes, say every ten seconds, the incentive may be decreased to nine free rentals, then eight, then seven, and so on. Such companion promotions may be directed to complimentary services, periodical subscriptions, etc.

The methods and systems according to the present invention may also be used in conjunction with a game. In one such embodiment, the consumer plays a question and answer game to receive a particular incentive. For example, in order to receive the maximum incentive, the consumer must correctly answer a predetermined number of questions correctly. In another such embodiment, as the incentive value decreases, the consumer is given opportunity to answer questions. If the consumer answers a question correctly, for example, the incentive value is increased slightly from the current value, and/or the time period for receiving the incentives is lengthened, and/or the timing is slowed.

Other variations and modifications of this invention will be apparent to those skilled in this art after careful study of this application. This invention is not to be limited except as set forth in the following claims.

What is claimed is:

1. A method for motivating a consumer to promptly indicate an interest in purchasing a product and/or service over a computer network, comprising the steps of:
presenting an offer for sale of a product and/or service to said consumer;
concurrently presenting to said consumer an incentive for purchasing said product and/or service promptly, wherein said incentive decreases over a period of time.

2. The method according to claim 1, wherein said incentive is initially set to a predetermined 15 maximum value.

3. The method according to claim 1, wherein said incentive is presented via a Web page.

4. The method according to claim 1, wherein said incentive is presented via a window.

5. The method according to claim 1, wherein said incentive is presented via a web banner.

6. The method according to claim 1, wherein said product and/or service offered for sale changes each time said consumer is presented with a new offer.

7. The method according to claim 6, wherein said new offer is presented to said consumer when said consumer revisits or refreshes said web page.

8. The method according to claim 1, wherein the value of said incentive decreases incrementally over a predetermined period of time.

9. The method according to claim 1, wherein said incentive comprises at least one of a discount off a purchase price, a purchase price, an increase in quantity of said product and/or service, and a higher quality product and/or service.

10. The method according to claim 1, wherein said incentive comprises a product and/or service having a variable value, and wherein said maximum value comprises a product and/or service having a high value decreasing to a product and/or service having a lower value.

11. The method according to claim 1, further comprising the steps of:
indicating an interest to purchase said product and/or service by said consumer at a point in time during said period of time; and
providing said consumer the current value of said incentive corresponding to the point in time at which said consumer indicated said interest.

12. The method according to claim 1, wherein a consumer who frequently uses said incentive for purchasing products and/or services is accorded a more favorable incentive than an consumer who infrequently uses said incentive to purchases goods and/or services.

13. The method according to claim 12, wherein said frequent consumer is accorded a higher maximum incentive.

14. The method according to claim 12, wherein said frequent consumer is accorded a higher minimum incentive.

15. The method according to claim 12, wherein said frequent consumer is accorded a longer time period for decreasing of said incentive from said maximum value down to said minimum value.

16. The method according to claim 1, wherein said offer is presented for a specific number of times during a predetermined time period.

17. The method according claim 16, wherein the presentation of said offer to a frequent consumer who frequently uses said method occurs more often.

18. The method according to claim 1, wherein said incentive corresponds to a profile of said consumer.

19. The method according to claim 18, wherein said profile comprises information relating to said consumer.

20. The method according to claim 19, wherein said information relates to said consumer's location.

21. The method according to claim 19, wherein said information relates to said consumer's preference.

22. The method according to claim 19, wherein said information relates to said consumers's historical behavior.

23. The method according to claim 1, wherein said incentive gradually decreases from said maximum value to a minimum value at a random rate during said predetermined period of time.

24. The method according to claim 1, wherein said incentive gradually decreases from said maximum value to a minimum value during said predetermined period of time, and wherein a first value of said incentive at a first point in said period of time may be less than or greater than a second value of said incentive at a second point in said period of time, said second point coming immediately prior to or immediately after said first point in time.

25. The method according to claim 1, wherein the value of said incentive decreases incrementally over a predetermined period of time.

26. The method according to claim 1, wherein said incentive comprises a discount.

27. The method according to claim 1, wherein said incentive comprises a purchase price.

28. The method according to claim 1, wherein said incentive comprises a product and/or service having a variable value, and wherein said maximum value comprises a product and/or service having a high value decreasing to a product and/or service having a lower value.

29. The method according to claim 1, wherein said incentive comprises a quantity of a product.

30. Code executable on a computer, said code comprising:
code for presenting an offer for sale of a product and/or service to a consumer;
code for concurrently presenting to said consumer an incentive for purchasing said product and/or service promptly, wherein said incentive decreases over a period of time.

31. The code executable on a computer according to claim 30, wherein said computer comprises a network server operable on a computer network.

32. The code executable on a computer according to claim 30, said code further comprising:
code for initially setting said incentive to a predetermined maximum value.

33. Code executable on a computer, said code comprising:
code for presenting an offer for sale of a product and/or service to a consumer;
code for concurrently presenting an incentive for purchasing said product and/or service to said consumer promptly, wherein said incentive decreases over a period of time;
code for receiving an indication to purchase said product and/or service by said consumer at a point in time during said period of time; and
code for providing said consumer the current value of said incentive corresponding to the point in time at which said consumer indicated said interest.

34. The code executable on a computer according to claim 33, wherein said computer comprises a network server operable on a computer network.

35. The code executable on a computer according to claim 33, said code further comprising:
code for initially setting said incentive to a predetermined maximum value.

36. A method for motivating a consumer to promptly indicate an interest in purchasing a product and/or service over a computer network comprising the steps of:
presenting an offer for sale of a product and/or service to said consumer over said computer network;
concurrently presenting an incentive for purchasing said product and/or service to said consumer promptly over said computer network, wherein said incentive is initially set to a predetermined maximum value and decreases over a period of time;
indicating an interest to purchase said product and/or service by said consumer at a point in time during said period of time; and
providing said consumer the current value of said incentive corresponding to the point in time at which said consumer indicated said interest.

37. An apparatus for motivating a consumer to promptly indicate an interest in purchasing a product and/or service over a computer network, said apparatus comprising:
means for presenting an offer for sale of a product and/or service from a server computer over said computer network to a customer's computer;
means for concurrently presenting an incentive for purchasing said product and/or service promptly, wherein said incentive is initially set to a predetermined maximum value and decreases over a period of time;
means for indicating an interest to purchase said product and/or service by said consumer at a point in time during said period of time; and
means for providing said consumer the current value of said incentive corresponding to the point in time at which said consumer indicated said interest.

38. A system for motivating a consumer to promptly indicate an interest in purchasing a product and/or service over a computer network, said consumer operating a customer terminal operable to act as a client on a network, said system comprising:
a host controller, the host controller comprising a computer operable to act as a server on said computer network and to communicate with said customer terminal over said computer network; and
data storage accessible to said host controller, said data storage storing information relating to said products and/or services for offering for purchase to said consumer,
the host controller being operable:
for presenting an offer for sale of a product and/or service from said server over said computer network to said customer terminal;
for concurrently presenting an incentive for purchasing said product and/or service promptly from said server over said computer network to said customer terminal, wherein said incentive is initially set to a predetermined maximum value and decreases over a period of time;
for receiving an indication of interest to purchase said product and/or service by said consumer from said customer terminal at a point in time during said period of time; and
for providing said consumer the current value of said incentive corresponding to the point in time at which said consumer indicated said interest.

39. A method for motivating a consumer to promptly indicate an interest in purchasing a product and/or service via a media, comprising the steps of:
presenting an offer for sale of a product and/or service to a consumer via said media;
concurrently presenting an incentive for purchasing said product and/or service to said consumer promptly via said media, wherein said incentive is initially set to a predetermined maximum value and decreases over a period of time;
indicating an interest to purchase said product and/or service by said consumer at a point in time during said period of time; and
providing said consumer the current value of said incentive corresponding to the point in time at which said consumer indicated said interest.

40. The method according to claim 39, wherein said media comprises television, radio, visual display, motion picture, telephone, periodical, and/or computer network.
